(19) United States
(12) Patent Application Publication
(10) Pub. No.: US 2016/0085869 A1
(43) Pub. Date: Mar. 24, 2016

(54) SOCIAL MEDIA CONTENT ANALYSIS AND OUTPUT

(71) Applicants: Walid MAGDY, Doha (QA); QATAR FOUNDATION, Doha (QA)

(72) Inventor: Walid Magdy, Doha (QA)

(21) Appl. No.: 14/890,834

(22) PCT Filed: Apr. 22, 2014
(86) PCT No.: PCT/EP2014/058066

§ 371 Date: Nov. 12, 2015

(30) Foreign Application Priority Data
May 13, 2013 (GB) 1308541.0

(51) Int. Cl. G06F 17/30

(52) U.S. Cl. CPC G06F 17/30867; G06F 17/30528; G06F 17/30598; G06F 17/3087

(57) ABSTRACT

A computer implemented method comprising: storing a set of social media objects, each social media object comprising at least one word. The method comprises identifying a subset of relevant social media objects from the set of social media objects by: storing at least one content article, extracting at least one keyword from at least one content article, ranking each extracted keyword with an importance value, searching each of the social media objects for each extracted keyword with an importance value that is higher than a predetermined value, and adding each social media object which comprises an extracted keyword with an importance value that is higher than the predetermined value to a subset of relevant social media objects. The method further comprises outputting the subset of relevant social media objects to a user.

The present invention relates to social media content analysis and output, and more particularly relates to the identification and output of relevant microblog entries.

Microblogging sites, such as Twitter, are currently one of the main platforms for exchanging time information and discussion in real time. There is a need to filter the large amount of information generated by microblogging sites so that only relevant information reaches users.

One simple microblog filtering technique is the “follow” feature on the Twitter platform. This feature allows a user to follow the posts made by other entities, persons, or events so that the user is fed with their tweets. This method is personalised according to a user's interests. Another method for following specific microblogs on Twitter involves searching for given hashtags (#tags), which are a common way for users to get updates about some topics based on the mention of the hashtag within the text of tweets. This method is less strict in filtering information, and more tweets are generally presented to user. However, many irrelevant tweets are often presented because of the misuse of hashtags by some users. Additionally, many tweets which are relevant to a hashtag topic may not include the hashtag itself, which leads to their absence in the retrieved results.

The present invention seeks to provide an improved system and method for social media content analysis and output.

According to one aspect of the present invention, there is provided a computer implemented method comprising: storing a set of social media objects, each social media object comprising at least one word, identifying a subset of relevant social media objects from the set of social media objects by: storing at least one content article, extracting at least one keyword from at least one content article, ranking each extracted keyword with an importance value, and searching each of the social media objects for each extracted keyword with an importance value that is higher than a predetermined value, and adding each social media object which comprises an extracted keyword with an importance value that is higher than the predetermined value to a subset of relevant social media objects, and outputting the subset of relevant social media objects to a user

Preferably, the method comprises storing a plurality of content articles which each comprise content relevant to the same geographic region.

Conveniently, the method further comprises: providing at least one predefined keyword, and searching each of the social media objects in the set of social media objects for each predefined keyword, and adding each social media object which comprises a predefined keyword to the subset of relevant social media objects.

Advantageously, the method further comprises: training a classifier with the content of the social media objects which comprise a predefined keyword, and using the classifier to analyse social media objects in the set of social media objects and adding the social media objects which are classified by the classifier as relevant social media objects to the subset of relevant social media objects.

Preferably, the social media object comprises a microblog entry, comment or status update.

Conveniently, the step of outputting the subset of relevant social media objects comprises outputting the subset of relevant social media objects to a user without outputting words from each content article other than words that are included in the relevant social media objects.

Advantageously, the method comprises outputting the subset of relevant social media objects to a user as a news portal comprising the relevant social media objects grouped into a plurality of different news categories.

According to another aspect of the present invention, there is provided a tangible computer machine readable medium storing instructions which, when executed by a computer, cause the computer to perform the method of any one of claims 1 to 7 defined hereinafter.

According to a further aspect of the present invention, there is provided a news portal comprising a subset of relevant social media objects outputted using the method of any one of claims 1 to 7 defined hereinafter, wherein the subset of social media objects are grouped in the news portal into a plurality of different categories.

Conveniently, the plurality of different categories are news categories.

Advantageously, the news portal is updated by repeating the above steps continuously or periodically.

Preferably, the news portal comprises social media objects grouped according to the popularity of the social media objects.

Conveniently, the news portal comprises a comments section to permit users to add comments to the news portal.

Accordingly to another aspect of the present invention, there is provided a system for analysing and outputting social media content, the system comprising: a memory operable to store a set of social media objects, each social media object comprising at least one word, an identification module operable to identify a subset of relevant social media objects from a set of social media objects stored in the memory by: storing at least one content article in the memory, extracting at least one keyword from at least one content article, ranking each extracted keyword with an importance value, and searching each of the social media objects for each extracted keyword with an importance value that is higher than a predetermined value, and adding each social media object which comprises an extracted keyword with an importance value that is higher than the predetermined value to a subset of relevant social media objects stored in the memory, wherein the system further comprises: an output module operable to output the subset of relevant social media objects to a user.

Preferably, the system is operable to store a plurality of content articles in the memory, the content articles comprising content relevant to the same geographic region.

Conveniently, the memory stores at least one predefined keyword and the identification module is operable to search each of the social media objects in the set of social media objects stored in the memory for each predefined keyword and to add each social media object which comprises a predefined keyword to the subset of relevant social media objects stored in the memory.

Advantageously, the system further comprises: a classifier module which is operable to be trained with the content of the social media objects which comprise a predefined keyword, the classifier module being operable to analyse social media object in the set of social media objects stored in the memory and to add the social media objects which are classified by the classifier module as relevant social media objects to the subset of relevant social media objects stored in the memory.

Preferably, the social media object comprises a microblog entry, comment or status update.

Conveniently, the output module is operable to output the subset of relevant social media objects to a user without outputting words from each content article other than words that are included in the relevant social media objects.

Advantageously, the output module is operable to output the subset of relevant social media objects to a user as a news portal comprising the relevant social media objects grouped into a plurality of different news categories.

So that the present invention may be more readily understood, embodiments of the present invention will now be described, by way of example, with reference to the accompanying drawings, in which:

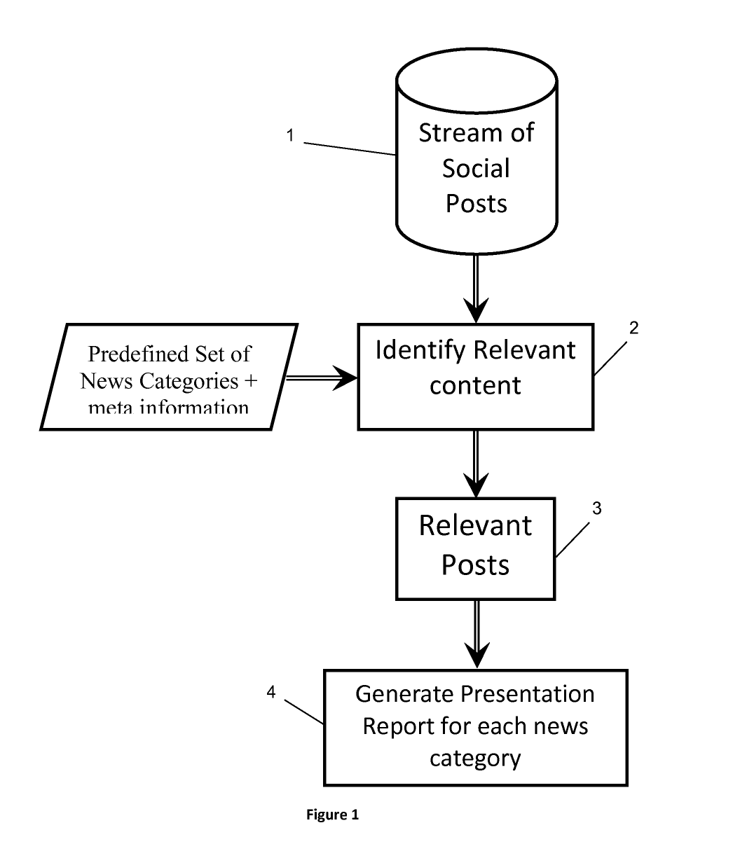

FIG. 1 is a flow diagram of a method of an embodiment of the invention,

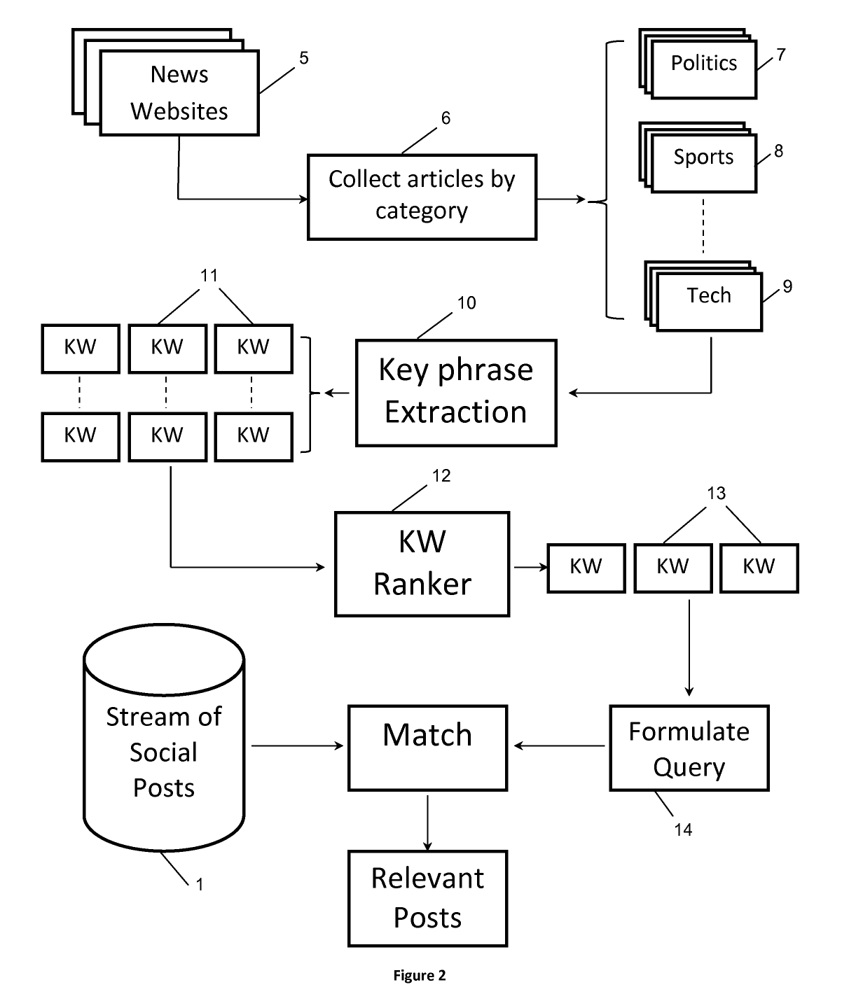

FIG. 2 is a flow diagram of part of the method of an embodiment of the invention for identifying microblogs that are relevant to news categories,

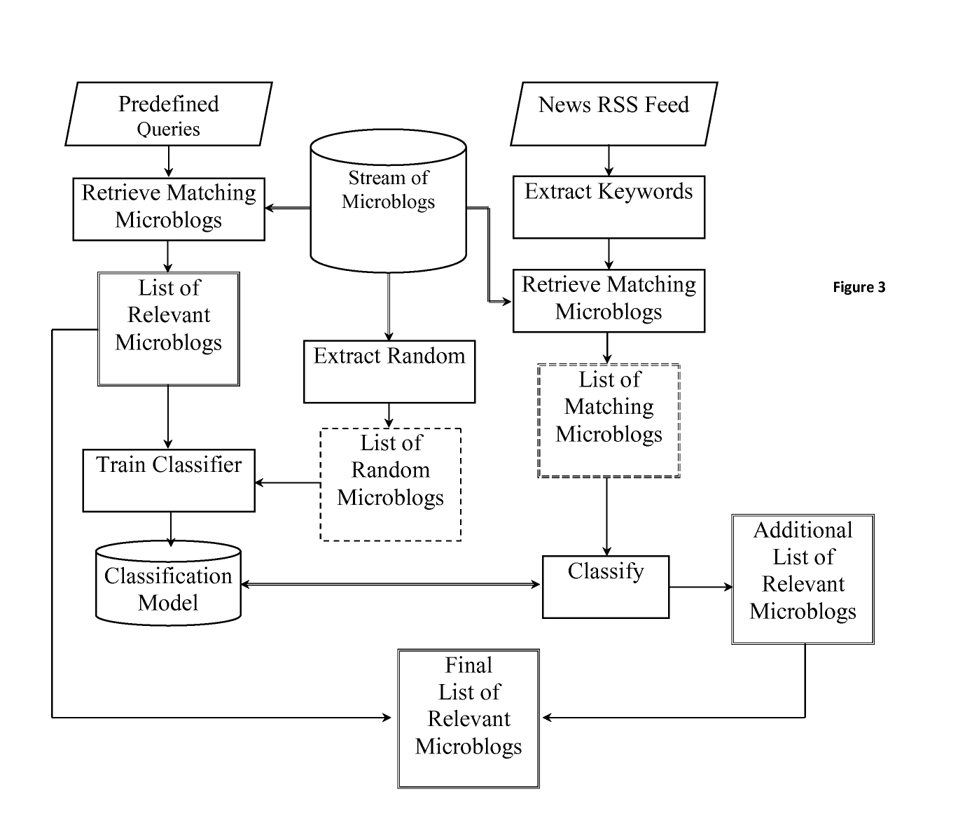

FIG. 3 is a flow diagram of another part of the method of an embodiment of the invention,

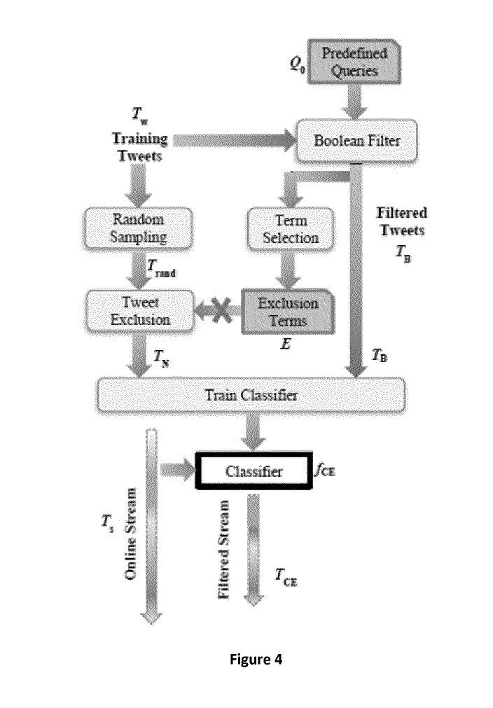

FIG. 4 is a flow diagram showing a microblogs filtering technique used in an embodiment of the invention, and

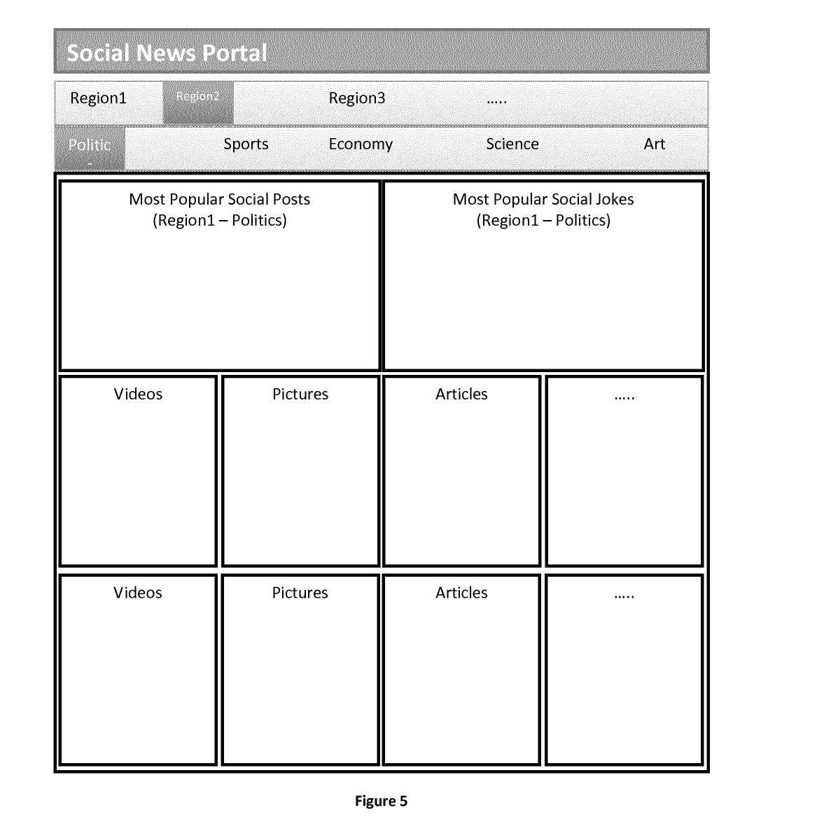

FIG. 5 is a schematic diagram of an example output of an embodiment of the invention in the form of a social news portal.

One embodiment of the invention is operable to output a news portal website comprising content which is generated at least partly or entirely from microblog entries, or other social media posts such as tweets. One embodiment of the invention presents the most popular content shared on Twitter regarding ongoing news in different regions. Visitors to the website can see a comprehensive report of the most popular tweets, jokes, videos, images, and news articles that people share as on Twitter related to the top news stories of the day.

Standard news sites inform visitors about what is happening in given regions. By contrast, an embodiment of the invention provides content which gives users an idea about what are the topics in news that people are interested in, and how they react towards them. In addition, it captures additional news stories or additional aspects of news stories shared on social media that may not exist in conventional news sites.

The method of an embodiment of the invention applies a microblog filtering technique for retrieving social media objects, such as microblog entries or tweets. Social media objects comprise comments, blog entries, microblog entries, status updates, sentiments and expressions. In one embodiment, social media objects are text strings of up to 140 characters. Another embodiment is configured for use with social media objects in the form of social posts in general such as posts to Facebook, blogs, or forums.

The method of an embodiment of the present invention is preferably a computer implemented method. A computer is operable to perform the steps of the method using computer hardware comprising a memory and a processor that are known to those skilled in the art. The method may be implemented on at least one computer which may be connected within a computer network, such as the Internet. Embodiments of the invention also extend to systems comprising hardware which is operable to implement the method.

The steps of the method are, in one embodiment, stored on a tangible computer readable medium. The computer readable medium is configured to be read by a computer which is operable to perform the steps of the method.

Referring initially to FIG. 1 of the accompanying drawings, a system and method of an embodiment of the invention comprise initially receiving a set of social media objects as a stream 1 of social media objects. Each social media object comprises at least one word. The system comprises an identification module 2 which receives the stream 1 of social media objects and identifies a subset of relevant social media objects 3 from the stream 1. The system comprises an output module 4 which is operable to aggregate the relevant social media objects 3 into an output format which can be presented to a user as a news portal.

The stream 1 of social media objects comprises a plurality of social media objects, such as microblogs, facebook statuses, links or any other kind of content generated by a user on a social media platform.

Referring now to FIG. 2 of the accompanying drawings, the identification module 2 is operable to identify relevant social media objects from the stream 1 by initially extracting information from at least one news website 5. The identification module 2 stores at least one content article by extracting an article or articles 6 from each news website 5. The identification module 2 groups the articles 6 into at least one different category, such as politics 7, sports 8 or technology 9.

The identification module 2 comprises a key phrase extraction module 10 which is operable to analyse the news articles in each category and to extract at least one key word or key phrases (KW). In one embodiment, the key phrase extraction module 10 is operable to extract named entities from each article. In embodiments of the invention, the key phrase extraction module 10 is operable to filter out certain predefined key words, such as the name of the article's author or other information that is not relevant to the content of the news article.

The identification module 2 comprises a key word ranking module 12 that receives the key words 11 extracted by the key word extraction module 10. The key word ranking module 12 ranks the extracted key words 11 with an importance value indicating relevance of the extracted key words 11 to the category of the news article. The ranking is carried out using a suitable ranking approach that would be familiar to a person skilled in the art, such as term frequency-inverse document frequency (TFIDF). The key word ranking module 12 outputs ranked key words 13. The identification module 12 incorporates a query formulation module 14 that receives the ranked key words 13 and generates a search query. The search query searches the social media objects for extracted key words with an importance value above a predetermined level. The search query thus identifies social media objects in the stream 1 that correspond to or match the ranked key words 13.

The identification module 2 adds the identified social media objects to a subset of relevant social media objects and outputs the matched social media objects to the output module 4. The output module 4 outputs the subset of relevant social media objects in the form of a news portal which groups the social media object into news categories.

Referring now to FIG. 3 of the accompanying drawings, a further embodiment of the invention comprises a more conservative approach to identifying relevant social media objects to the embodiment described above. The conservative approach applied by the embodiment of FIG. 3 yields more precise results by applying a scalable filtering approach to the stream of social media objects. This embodiment is described in more detail below.

### 1. Retrieving an Initial Set of Relevant Microblogs

Any geographic region has a set of predetermined values, referred to here as key players, who are expected to appear often in news headlines. For example, “Obama” is a key player in US politics. The set of key players is nearly static since the set does not change frequently over time. Therefore, a list of accurate predefined queries representing key player in a certain region is prepared to retrieve an initial set of relevant microblogs. Queries may include politicians, parties, institutes or other persons or entities and their corresponding Twitter accounts.

The set of key players requires updating every few months or years according to changes in the region. The queries are set carefully to achieve high precision to avoid the retrieval of irrelevant microblogs. For example, setting a query “Obama” referring to the US president is acceptable, since most of the microblogs talking about “Obama” refer to the president himself. While searching for “Clinton” as a query for “Bill Clinton” can lead to the retrieval of a large number of irrelevant microblogs for those microblogs referring to “Hillary Clinton”. Therefore, in the latter case, it is better to have the query as “Bill Clinton” to improve the precision of the results.

Streams of microblogs that match any of the predefined key words or queries are considered relevant. Matching microblogs are referred to as a set of Key Players Microblogs set (MicroblogsKP).

### 2. Retrieving a Set of Potentially Relevant Microblogs

Microblogs about accidental regional news may not be captured with the set of predefined queries. To overcome this problem, news is explored on one or more news sites, and keywords are extracted, as shown in FIG. 2.

The method comprises identifying one or more news websites and grouping articles on the websites into different categories, such as politics, sport and technology.

Key phrases (KW) are extracted from the categorised articles. The key phrases are extracted using a method known to those skilled in the art for identifying and extracting the most important key phrases in an article. In one embodiment, named entities are extracted from the articles. The method preferably filters out certain key words, such as the name of the author of the article so that the author's name is not confused with a relevant key phrase.

Extracted key phrases are then ranked with an importance value based on the importance and the relevance to the news category of the article. This is achieved using a ranking approach known to those skilled in the art, such as term frequency-inverse document frequency (TF-IDF).

The extracted key phrases are then used to formulate search queries applied to a stream of social posts, such as microblogs. The social posts which include the key phrases are matched and considered to be relevant posts. Keywords usually exist as metadata in news articles. Collected keywords are used to retrieve additional microblogs. Microblogs matching keywords are assigned to a relevance classifier since keywords may include general or incorrect terms that can lead to the retrieval of large number of irrelevant microblogs. The extracted keywords are each ranked by the classifier with an importance value and keywords with an importance value that is higher than a predetermined value are used in the classifier to search and identify a subset of relevant microblogs. This subset of microblogs is referred to as Keywords Microblogs (MicroblogsKW).

### 3. Classifying Microblogs

In one embodiment, a support vector machine (SVM) classifier is trained with MicroblogsKP acting as the positive examples and a set of randomly selected microblogs as negative examples (MicroblogsN). MicroblogsN should not match the predefined queries or the extracted keywords from news.

This guarantees: MicroblogsN∩(MicroblogsKW∪MicroblogsKP)=φ.

The number of negative examples is selected to be N times the number of positive examples since the spectrum of irrelevant microblogs is expected to be much wider. In one embodiment N is 10. Positive and negative examples are selected from a recent period of time, preferably 24 hours, to represent recent data.

The set of features used to train the SVM classifier comprises the terms appearing in MicroblogsKP. In addition, a feature is used to represent the percentage of terms in a microblog that do not match any of the terms. The generated model is then used to classify MicroblogsKW. Classified relevant microblogs are added to MicroblogsKP to form the full set of relevant microblogs. Finally a comprehensive report is generated which comprises these microblogs.

The process of training the classifier is applied periodically to keep the user updated with microblogs relevant to news in real-time. Typically, the microblogs classified as relevant enrich the total number of relevant microblogs significantly; especially when accidental news occurs with new entities. Subjectively, the increase of relevant microblogs ranges between 50% and 300% according to the type of news at that time, and the precision exceeds 90%.

Referring now to FIG. 4 of the accompanying drawings, a further embodiment of the invention comprises scalable filtering steps which apply scalable filtering to a stream of microblogs or other social posts. This further embodiment applies a more conservative approach to identifying relevant microblogs and may lead to more precise results and is more general to be applies on news or different topics, such as following microblogs related to healthcare, TV shows, disasters . . . etc.

The filtering of relevant microblogs is discussed below in more detail. Boolean filtering, Boolean filtering with query expansion and classifier-based filtering techniques are known to those skilled in the art. These filtering techniques can be used as the relevant tweets collection component but with limited performance. They are described below to provide background information on the filtering techniques before the filtering technique of an embodiment of the invention is described. The fourth presented filtering technique is novel and achieves much better performance for following dynamic and broad topics such as news on politics and sports, from the recall and precision perspectives.

### Boolean Filtering

The simplest filtering technique is the one that views Q₀ as a set of Boolean queries and therefore applies a Boolean filter, denoted by f_{B}, to track microblogs that satisfy any of the queries in Q₀ in the upcoming stream. The resulting matched microblogs are denoted by T_{B}. The effectiveness of this technique depends on the quality of the selected queries in Q₀; if they are selected precisely, it is expected to retrieve results of very high precision; however recall is expected to be low when topics are highly dynamic.

### Boolean Filtering with Query Expansion

A classical idea that extends the Boolean filter f_{B} to achieve better recall is to apply query expansion using the initial query set Q₀, aiming to match more microblogs. In this approach, a set of expansion terms E is added to Q₀ using pseudo relevance feedback. The new terms are selected from terms in the set of microblogs T_{B} that are matched by f_{B} in a given window of time w. In our context, w should precede the beginning of the online filtering process, resembling a training-like period. We denoted the set microblogs in the training period by T_{w}. Each term t that appears in T_{B} is scored using TF_IDF as in the following equation:

$${TF\_IDF}_{w} ( t ) = {tf}_{B} ( t ) \cdot log \frac{{N}_{w}}{{df}_{w} ( t )}$$

### Classifier-Based Filtering

Since Boolean filters are strict, a classifier-based filter is expected to get even higher recall. To train a binary classifier, samples of positive and negative examples are required. It is straight forward to use the set of microblog T identified by f as the positive sample since it is expected to be of high precision (compared to T_{BE}). A random sample T_{rand} of the microblogs that do not match Q₀ can then act as the negative sample. The trained classifier is then used to classify the stream of microblogs into relevant or irrelevant. We refer to the resulting classifier as f_{C}. This filtering technique can be less strict, since terms can be used as features which helps in finding relevant microblogs that do not match Q₀. However, the main concern about f_{C} is the potential risk of feeding a negative sample out of random microblogs that might possibly include some of the actual relevant microblogs. This happens when those relevant microblogs are not picked by f_{B} due to the static nature of Q₀, leading to a trained classifier that is confused over good features. This last concern is one of the key motivations behind the classifier-and-exclusion-based filtering approach that is discussed below.

### Classifier-and-Exclusion-Based Filtering

An embodiment of the invention seeks to achieve higher recall while preserving acceptable levels of precision by using classifier-and-exclusion-based filtering. FIG. 4 illustrates the blocks of this filtering method.

The method is unsupervised classifier-based, and the key idea behind it is the novel way the method utilizes the expansion terms in the filtering process. Similar to f_{C}, a binary classifier is trained to filter an online stream of microblogs. While the positive sample for training the classifier remains the same as in f_{C}, the negative sample is drawn differently. A random sample T_{rand} is similarly drawn from microblogs that appear in the training microblogs T_{w} but not in T_{B}, however it is not directly used as a negative sample to train the classifier.

A set of expansion terms E are selected from terms that appear in T_{B}, but instead of adding them to Q₀ (as used in f_{BE}), they are used to exclude potentially-relevant microblogs that match E (i.e., microblogs that include any of the expansion terms E) from T_{rand}, before eventually using the resulting set of microblogs, denoted by T_{N}, as a negative sample to train the binary classifier. This process tries to minimize the chance that the negative sample might contain microblogs that are possibly relevant to the topic. The rationale is that E can match many potentially-relevant microblogs, and thus can “clean” the negative sample from those noisy examples that would negatively affect the performance of the classifier. The fact that it might also match irrelevant microblogs as well, and thus exclude them from the negative sample, should not have negative effect since T_{rand} is naturally of no shortage of non-relevant microblogs. We refer to the final trained classifier as f_{CE}.

In practical use of f_{CE}, the processes of term selection and classifier training are applied periodically to frequently adapt to the expected changes and drifts in the targeted topic. Both the window of time w for collecting the training samples and the frequency of updating the classifier depend on the dynamicity and broadness of the topic. For example, w is set to 20 hours of microblogs stream, and the classifier is updated every 4 hours by retraining it on the past w hours.

One embodiment uses a support vector machines (SVM) classifier. Each microblog is represented as a feature vector. Terms are used as the features and feature values are all binary based on the existence of the terms in the microblog. Since the classifier is trained periodically, it is expected that the set of terms used as features change over time as the training samples change. For an efficient process, we reduce the feature space by selecting only the terms that appear more than 10 times in T_{B} as the features, after removing stop words. Terms that appear in a microblog but not in the feature space are represented by an additional special feature, denoted by miss, which is defined as the percentage of terms in the microblog that do not exist as features in the feature space. For example, if a microblog has 10 terms after stop-word removal, and only two terms exist in the feature space and the rest do not, then the corresponding features of the two existing terms will be set to one, and miss will be set to 0.8. During the filtering process, the classifier assigns a score to each microblog; we only consider microblogs of positive scores as relevant.

We note that the set of features are different from one topic to the other and from one training instance to another even for the same topic, since it depends on the terms appearing in the set T_{B}, which changes periodically. We also elect to set the size of the negative samples to be ten times the size of the positive sample, to better cover the wide space of the non-relevant microblogs.

Once the filtering approach has identified relevant microblogs, the method outputs the identified relevant microblogs to a user. FIG. 5 shows an example layout of an output of relevant microblogs in the form of a social news portal. The content output on the social news portal is composed preferably entirely of relevant social media objects. A user can therefore view the social news portal to be provided with up to date information on topics that are of interest to the user.

One example of an embodiment of the invention which is known as TweetMogaz (www.tweetmogaz.com) is running over a collection of Arabic tweets. The method collects an average of 3-4 million Arabic tweets per day. Tweet text is pre-processed using normalization techniques for social Arabic text and indexed using Apache Solr. Search is enabled by specifying a query and time span, and results are presented in a comprehensive report. The homepage of TweetMogaz displays a real-time report about political news in the past 24 hours for countries in the Arabic region including Egypt and Syria. Tens of thousands of tweets are identified daily as relevant to each region using the presented filtering approach. The number of relevant tweets can reach up to 300 k tweets on days with hot news, such as the Egyptian presidential elections day, and the days when there are severe battles between the Syrian free army and the regime's army. User can see examples of these days by browsing archived daily reports on the website.

The method for retrieving and filtering relevant microblogs performs well. In one embodiment, the method is applied to follow political news in counties in the Arabic region such as the Egypt and Syria. However, the method is applicable to other regions and other news categories.

Previous work in microblog retrieval focused on analyzing the search process, improving ad-hoc microblog search, and developing platforms for improved user experience with search through analyzing results. Additional work studied the role of microblogs in news reporting and discovery, and how users' profiles can be used for news recommendation. Other work investigated detecting comments about news from Twitter to be presented to readers along with news articles.

Recently, microblog filtering grabbed some attention as an important task for allowing users to follow certain topics. Microblog filtering was introduced as a new task in TREC Microblog track 2012, where the aim was to filter a feed of tweets by getting relevant ones to some topics. The best achieved result in the track got a precision of 0.6, which is considerably low for usage in a practical environment.

The system of embodiments of the invention applies microblog filtering for getting microblogs relevant to regional news in a practical environment with high precision. Search results are presented to user in the form of a comprehensive report. The system provides users with a summary about the public response towards ongoing news.

An embodiment of the present invention seeks to provide a news portal that offers a better user experience than conventional systems that retrieve and present relevant microblogs.

The system preferably outputs the news portal in the form of a subset of relevant social media objects without outputting words from a corresponding news article, other than words that are included in the relevant social media objects.

An embodiment of the invention provides a content-driven filtering approach which is based on public news and top stories to identify social content which can reflect the public interest on a regional level. This provides a distinct benefit over conventional systems that simply filter social content based on a user's preferences and interests.

An embodiment of the invention seeks to couple news and social media to create a novel platform that works as a news portal generated from the social content itself using the novel information filtering technique described above. This provides a distinct benefit over conventional systems that identify relevant social content and simply display the social content alongside a corresponding news article.

When used in this specification and the claims, the term “comprises” and “comprising” and variations thereof mean that specified features, steps or integers and included. The terms are not to be interpreted to exclude the presence of other features, steps or compounds.

### TECHNIQUES FOR IMPLEMENTING ASPECTS OF EMBODIMENTS OF THE INVENTION

1. K. Darwish, W. Magdy, A. Mourad (2012). Language Processing for Arabic Microblog Retrieval. CIKM 2012
2. A. Kuthari, W. Magdy, K. Darwish, A. Mourad, A. Taei. (2013). Detecting Comments on News Articles in Microblogs. ICWSM 2013
3. W. Magdy, A. Ali, K. Darwish (2012). A Summarization Tool for Time-Sensitive Social Media. CIKM 2012
4. N. Naveed, T. Gottron, J. Kunegis, A. Alhadi. (2011). Searching microblogs: coping with sparsity and document quality. CIKM 2011.
5. O. Phelan, K. McCarthy, M. Bennett, and B. Smyth. (2011). Terms of a feather: content-based news recommendation and discovery using twitter. ECIR 2011.
6. I. Soboroff, I. Ounis, J. Lin, I. Soboroff. (2012). Overview of the TREC-2012 Microblog Track. TREC 2012
7. I. Subasic, B. Berendt. (2011). Peddling or Creating? Investigating the Role of Twitter in News Reporting. ECIR-2011
8. J. Teevan, D. Ramage, M. Morris. (2011). #Twittersearch: A comparison of microblog search and web search. WSDM 2011.
9. S. R. Yerva, Z. Miklós, F. Grosan, A. Tandrau, K. Aberer. (2012). TweetSpector: Entity-based retrieval of Tweets. SIGIR 2012

1. A computer implemented method comprising:
storing a set of social media objects, each social media object comprising at least one word,
identifying a subset of relevant social media objects from the set of social media objects by:
storing at least one content article,
extracting at least one keyword from at least one content article,
ranking each extracted keyword with an importance value, and
searching each of the social media objects for each extracted keyword with an importance value that is higher than a predetermined value, and
adding each social media object which comprises an extracted keyword with an importance value that is higher than the predetermined value to a subset of relevant social media objects, and outputting the subset of relevant social media objects to a user.

2. The method of claim 1, wherein the method comprises storing a plurality of content articles which each comprise content relevant to the same geographic region.

3. The method of claim 1 or claim 2, wherein the method further comprises:
providing at least one predefined keyword, and
searching each of the social media objects in the set of social media objects for each predefined keyword, and
adding each social media object which comprises a predefined keyword to the subset of relevant social media objects.

4. The method of claim 3, wherein the method further comprises:
training a classifier with the content of the social media objects which comprise a predefined keyword, and
using the classifier to analyse social media objects in the set of social media objects and adding the social media objects which are classified by the classifier as relevant social media objects to the subset of relevant social media objects.

5. The method of any one of the preceding claims, wherein a social media object comprises a microblog entry, comment or status update.

6. The method of any one of the preceding claims, wherein the step of outputting the subset of relevant social media objects comprises outputting the subset of relevant social media objects to a user without outputting words from each content article other than words that are included in the relevant social media objects.

7. The method of any one of the preceding claims, wherein the method comprises outputting the subset of relevant social media objects to a user as a news portal comprising the relevant social media objects grouped into a plurality of different news categories.

8. A tangible computer machine readable medium storing instructions which, when executed by a computer, cause the computer to perform the method of any one of claims 1 to 7.

9. A news portal comprising a subset of relevant social media objects outputted using the method of any one of claims 1 to 7, wherein the subset of social media objects are grouped in the news portal into a plurality of different categories.

10. The news portal of claim 9, wherein the plurality of different categories are news categories.

11. The news portal of claim 9 or claim 10, wherein the news portal is updated by repeating the method of any one of claims 1 to 7 continuously or periodically.

12. The news portal of any one of claims 9 to 11, wherein the news portal comprises social media objects grouped according to the popularity of the social media objects.

13. The news portal of any one of claims 9 to 12, wherein the news portal comprises a comments section to permit users to add comments to the news portal.

14. A system for analysing and outputting social media content, the system comprising:
a memory operable to store a set of social media objects, each social media object comprising at least one word,
an identification module operable to identify a subset of relevant social media objects from a set of social media objects stored in the memory by:
storing at least one content article in the memory,
extracting at least one keyword from at least one content article,
ranking each extracted keyword with an importance value, and
searching each of the social media objects for each extracted keyword with an importance value that is higher than a predetermined value, and
adding each social media object which comprises an extracted keyword with an importance value that is higher than the predetermined value to a subset of relevant social media objects stored in the memory, wherein the system further comprises:
an output module operable to output the subset of relevant social media objects to a user.

15. The system of claim 14, wherein the system is operable to store a plurality of content articles in the memory, the content articles comprising content relevant to the same geographic region.

16. The system of claim 14 or claim 9, wherein the memory stores at least one predefined keyword and the identification module is operable to search each of the social media objects in the set of social media objects stored in the memory for each predefined keyword and to add each social media object which comprises a predefined keyword to the subset of relevant social media objects stored in the memory.

17. The system of claim 16, wherein the system further comprises:
a classifier module which is operable to be trained with the content of the social media objects which comprise a predefined keyword, the classifier module being operable to analyse social media object in the set of social media objects stored in the memory and to add the social media objects which are classified by the classifier module as relevant social media objects to the subset of relevant social media objects stored in the memory.

18. The system of any one of claims 14 to 17, wherein a social media object comprises a microblog entry, comment or status update.

19. The system of any one of claims 14 to 18, wherein the output module is operable to output the subset of relevant social media objects to a user without outputting words from each content article other than words that are included in the relevant social media objects.

20. The system of any one of claims 14 to 19, wherein the output module is operable to output the subset of relevant social media objects to a user as a news portal comprising the relevant social media objects grouped into a plurality of different news categories.
